(19) United States
(12) Patent Application Publication
(10) Pub. No.: US 2012/0295146 A1
(43) Pub. Date: Nov. 22, 2012

(54) BATTERY HOLDER

(75) Inventor: YONG-JUN SONG, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/217,259

(22) Filed: Aug. 25, 2011

(30) Foreign Application Priority Data
May 19, 2011 (CN) 201110130366.7

(51) Int. Cl. H01M 2/10

(52) U.S. Cl. 429/100

(57) ABSTRACT

A battery holder for a button battery includes a base, and a cover on the base to enclose the button battery. A first conductive piece extends from the base. A second conductive piece extends from the cover. The anode and the cathode of the button battery are respectively connected to the second conductive piece and the first conductive piece for the outward supply of electricity.

### BACKGROUND

1. Technical Field

The present disclosure relates to a battery holder.

2. Description of Related Art

In many computer systems, button batteries are commonly used to power complementary metal oxide semiconductor (CMOS) chips on motherboards. However, sometimes, a button battery may be loosened, and as a result, the CMOS chip will stop working, which is undesirable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a battery holder, together with a button battery.

FIG. 2 is an inverted view of FIG. 1.

FIG. 3 is an isometric view of the holder of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

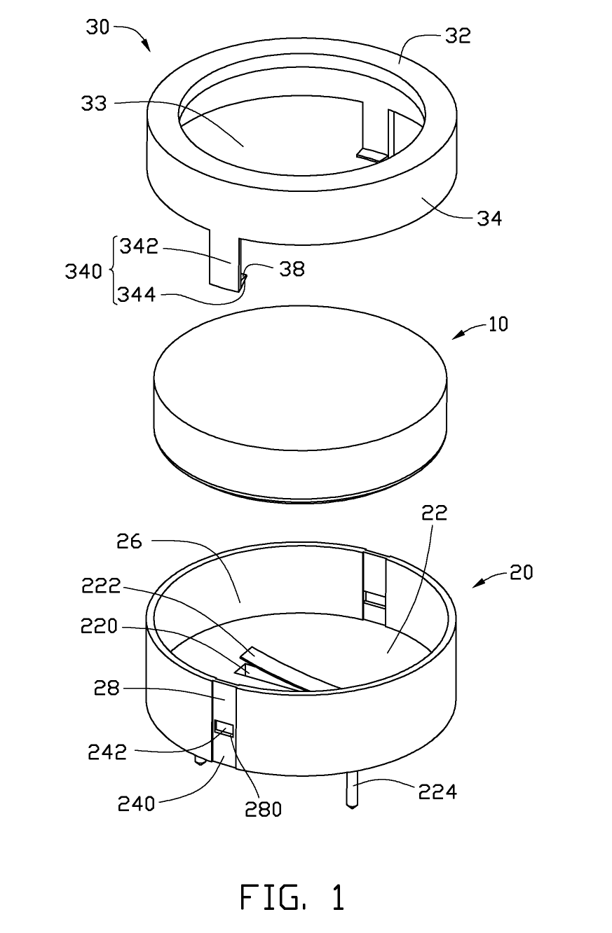

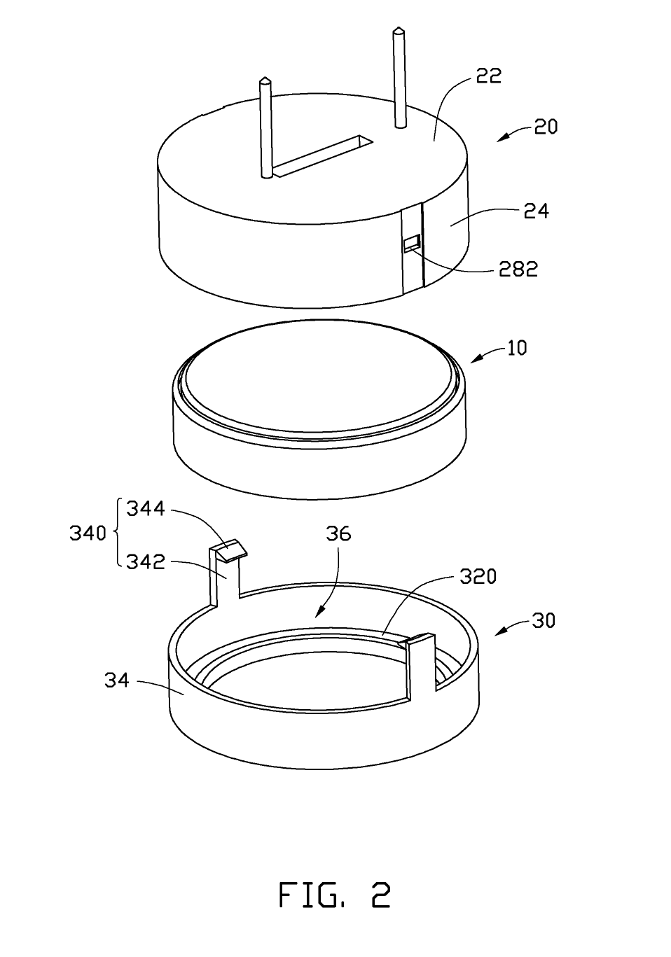

Referring to FIGS. 1 and 2, an exemplary embodiment of a battery holder in which a button battery 10 may be installed includes a base 20 and a cover 30.

The base 20 includes a substantially circular bottom wall 22 and a first sidewall 24 extending in a substantially perpendicular manner from the circumference of the bottom wall 22. A first receiving space 26 is bounded by the bottom wall 22 and the first sidewall 24. A rectangular slot 220 is defined in the bottom wall 22. A first conductive piece 222 is mounted to the bottom wall 22 in the receiving space 25 at a first end of the slot 220, and slants up toward the second end of the slot 220 opposite to the first end in the first receiving space 26. Two pins 224 (anode pin 224 and cathode pin 224) extend in a substantially perpendicular manner from the outer surface of the bottom wall 22 opposite to the receiving space 26. The cathode pin 224 is located at the first end of the slot 220 and is electrically connected to the first conductive piece 222 in the bottom wall 22. The other pin 224 is located adjacent to the second end of the slot 220. Two diametrically opposing recesses 240 are defined in an outer surface of the first sidewall 24. A latching hole 242 through the inner surface of the first sidewall 24 is defined in each recess 240. A second conductive piece 28 is mounted in one of the recesses 240, and extends through the bottom wall 22 to connect to the other pin 224. A through hole 280 is defined in the second conductive piece 28, aligning with the latching hole 242. An extension piece 282 extends in a substantially perpendicular manner from the second conductive piece 28 to contact the top side of the latching hole 242.

The cover 30 includes a circular top wall 32 defining an opening 33 in the center and a second sidewall 34 extending in a substantially perpendicular manner from the circumference of the top wall 32. A second receiving space 36 is bounded by the top wall 32 and by the second sidewall 34. A circular third conductive piece 320 is mounted on the inner surface of the top wall 32. Two inwardly-acting opposing latches 340 extend from the second sidewall 34, away from the top wall 32. Each latch 340 includes an elastic extension portion 342 extending from the second sidewall 34, and a hook 344 extending from the distal end of the extension portion 342 toward the other latch 34. A fourth conductive piece 38 forms the outer face of the inner surface of one of the hooks 344, and the fourth conductive piece 38 extends through the corresponding extension portion 342 and the second sidewall 34, to be connected to the third conductive piece 320.

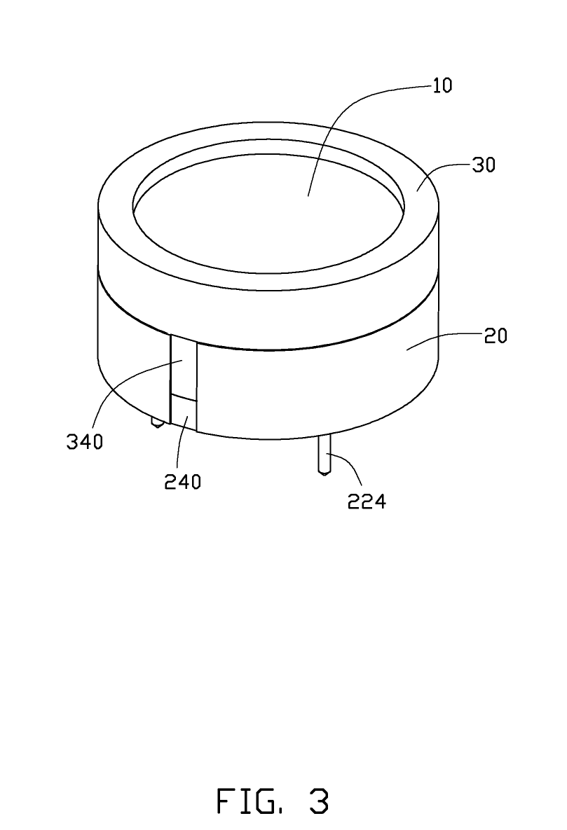

Referring to FIG. 3, in assembly, the button battery 10 is received in the first receiving space 26. The cathode of the button battery 10 makes contact with the first conductive piece 222. Therefore, the cathode of the button battery 10 is electrically connected to the cathode pin 224 at the first end of the slot 220 through the first conductive piece 222. The cover 30 is placed on the base 20. The extension portions 342 are received in the corresponding recesses 240, and the hooks 344 engage in the corresponding latching holes 242. Therefore, the cover 30 is fixed to the base 20, and button battery 10 will not be loosened. At this time, the fourth conductive piece 38 is electrically connected to the second conductive piece 28. The anode of the button battery 10 extends into the second receiving space 36 and contacts the third conductive piece 320. Therefore, the anode of the button battery 10 is electrically connected to the anode pin 224 at the second end of the slot 220 through the third conductive piece 320, the fourth conductive piece 38, and the second conductive piece 28.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A battery holder for installing a button battery, the battery holder comprising:
a base to support the button battery, the base forming a first conductive piece to be connected to the cathode of the button battery, a first pin extending down from a bottom of the base and connected to the first conductive piece, and a second pin extending down from the bottom of the base; and
a cover to be mounted on the base to fix the button battery with the base, the cover forming a second conductive piece to be connected the second pin and the anode of the button battery.

2. The battery holder of claim 1, wherein the base comprises a circular bottom wall and a first sidewall extending in a substantially perpendicular manner from the circumference of the bottom wall, a first receiving space is bounded by the bottom wall and the first sidewall to receive a lower portion of the button battery, the cover comprises a top wall and a second sidewall extending in a substantially perpendicular manner from the circumference of the top wall, a second receiving space is bounded by the top wall and the second sidewall to receive an upper portion of the button battery.

3. The battery holder of claim 2, wherein a rectangular slot is defined in the bottom wall, the first conductive piece extends from a first end of the slot toward a second end of the slot opposite to the first end in the first receiving space.

4. The battery holder of claim 2, wherein the second conductive piece is mounted to an inner surface of the top wall.

5. The battery holder of claim 2, wherein the first sidewall defines two opposite recesses, two opposite latches extend from the second sidewall and are to be engaged in the recesses respectively, a third conductive piece extends on one of the recesses and is connected to the second pin, a fourth conductive piece extends on one of the latches and is connected to the second conductive piece, to be electrically connected to the third conductive piece.

6. The battery holder of claim 5, wherein a latching hole is defined in each recess, each latch comprises an extension portion to be received in a corresponding one of the recesses, and a hook extending from the distal end of the extension portion and engaging in the latching hole of the corresponding recess.

7. The battery holder of claim 6, wherein a through hole is defined in the third conductive piece and aligns with the latching hole of the corresponding recess, an extension piece extends from the third conductive piece to contact the top side bounding the corresponding latching hole, the fourth conductive piece extends through one of the extension portion from the second conductive piece and covers the inner surface of the corresponding hook.
